(19) United States
(12) Patent Application Publication
(10) Pub. No.: US 2009/0146054 A1
(43) Pub. Date: Jun. 11, 2009

(54) END CAP VOLTAGE CONTROL OF ION TRAPS

(75) Inventor: David Rafferty, Webster, TX (US)

Correspondence Address: FISH & RICHARDSON P.C., P.O BOX 1022, Minneapolis, MN, 55440-1022, US

(73) Assignee: SPACEHAB, INC., Houston, TX (US)

(21) Appl. No.: 12/329,787

(22) Filed: Dec. 8, 2008

Related U.S. Application Data
(60) Provisional application No. 61/012,660, filed on Dec. 10, 2007.

(51) Int. Cl. H01J 49/00

(52) U.S. Cl. 250/281

(57) ABSTRACT

An ion trap for a mass spectrometer has a conductive central electrode with an aperture extending from a first open end to a second open end. A conductive first electrode end cap is disposed proximate to the first open end thereby forming a first intrinsic capacitance between the first end cap and the central electrode. A conductive second electrode end cap is disposed proximate to the second open end thereby forming a second intrinsic capacitance between the second end cap and the central electrode. A first circuit couples the second end cap to a reference potential. A signal source generating an AC trap signal is coupled to the central electrode. An excitation signal is impressed on the second end cap in response to a voltage division of the trap signal by the first intrinsic capacitance and the first circuit.

### CROSS-REFERENCE TO RELATED APPLICATIONS

This application claims priority to U.S. provisional application Ser. No. 61/012,660 filed on Dec. 10, 2007, which is hereby incorporated by reference herein.

### TECHNICAL FIELD

This invention relates to ion traps, ion trap mass spectrometers, and more particularly to control signal generation for an ion trap used in mass spectrometric chemical analysis.

### BACKGROUND

Using an ion trap is one method of performing mass spectrometric chemical analysis. An ion trap dynamically traps ions from a measurement sample using a dynamic electric field generated by a driving signal or signals. The ions are selectively ejected corresponding to their mass-charge ratio (mass (m)/charge (z)) by changing the characteristics of the electric field (e.g., amplitude, frequency, etc.) that is trapping them. More background information concerning ion trap mass spectrometry may be found in “Practical Aspects of Ion Trap Mass Spectrometry,” by Raymond E. March et al., which is hereby incorporated by reference herein.

Ramsey et al. in U.S. Pat. Nos. 6,469,298 and 6,933,498 (hereafter the “Ramsey patents”) disclosed a sub-millimeter ion trap and ion trap array for mass spectrometric chemical analysis of ions. The ion trap described in U.S. Pat. No. 6,469,298 includes a central electrode having an aperture; a pair of insulators, each having an aperture; a pair of end cap electrodes, each having an aperture; a first electronic signal source coupled to the central electrode; and a second electronic signal source coupled to the end cap electrodes. The central electrode, insulators, and end cap electrodes are united in a sandwich construction where their respective apertures are coaxially aligned and symmetric about an axis to form a partially enclosed cavity having an effective radius R₀ and an effective length 2Z₀, wherein R₀ and/or Z₀ are less than 1.0 millimeter (mm), and a ratio Z₀/R₀ is greater than 0.83.

George Safford presents a “Method of Mass Analyzing a Sample by use of a Quadrupole Ion Trap” in U.S. Pat. No. 4,540,884, which describes a complete ion trap based mass spectrometer system.

An ion trap internally traps ions in a dynamic quadrupole field created by the electrical signal applied to the center electrode relative to the end cap voltages (or signals). Simply, a signal of constant frequency is applied to the center electrode and the two end cap electrodes are maintained at a static zero volts. The amplitude of the center electrode signal is ramped up linearly in order to selectively destabilize different masses of ions held within the ion trap. This amplitude ejection configuration does not result in optimal performance or resolution and may actually result in double peaks in the output spectra. This amplitude ejection method may be improved upon by applying a second signal to one end cap of the ion trap. This second signal causes an axial excitation that results in the resonance ejection of ions from the ion trap when the ions' secular frequency of oscillation within the trap matches the end cap excitation frequency. Resonance ejection causes the ion to be ejected from the ion trap at a secular resonance point corresponding to a stability diagram beta value of less than one. A beta value of less than one is traditionally obtained by applying an end cap (axial) frequency that is a factor of 1/n times the center electrode frequency, where n is typically an integer greater than or equal to 2.

Moxom et al. in “Double Resonance Ejection in a Micro Ion Trap Mass Spectrometer,” Rapid Communication Mass Spectrometry 2002, 16: pages 755-760, describe increased mass spectroscopic resolution in the Ramsey patents device by the use of differential voltages on the end caps. Testing demonstrated that applying a differential voltage between end caps promotes resonance ejection at lower voltages than the earlier Ramsey patents and eliminates the “peak doubling” effect also inherent in the earlier Ramsey patents. This device requires a minimum of two separate voltage supplies: one that must control the radio frequency (RF) voltage signal applied to the central electrode and at least one that must control the end cap electrode (the first end cap electrode is grounded, or at zero volts, relative to the rest of the system).

Although performance of an ion trap may be increased by the application of an additional signal applied to one of the ion trap's end caps, doing so increases the complexity of the system. The second signal requires electronics in order to generate and drive the signal into the end cap of the ion trap. This signal optimally needs to be synchronized with the center electrode signal. These additional electronics increase the size, weight, and power consumption of the mass spectrometer system. This could be very important in a portable mass spectrometer application.

### SUMMARY

An ion trap comprises a conductive ring-shaped central electrode having a first aperture extending from a first open end to a second open end. A signal source generates a trap signal having at least an alternating current (AC) component between a first and second terminal. The first terminal is coupled to the central electrode and the second terminal is coupled to a reference voltage potential. A conductive first electrode end cap is disposed adjacent to the first open end of the central electrode and coupled to the reference voltage potential. A first intrinsic capacitance is formed between a surface of the first electrode end cap and a surface of the first open end of the central electrode.

A conductive second electrode end cap is disposed adjacent to the second open end of the central electrode and coupled to the reference voltage potential with a first electrical circuit. A second intrinsic capacitance is formed between a surface of the second electrode end cap and a surface of the second open end of the central electrode. An excitation voltage that is a fractional part of the trap signal is impressed on the second end cap in response to a voltage division of the trap signal by the second intrinsic capacitance and an impedance of the first electrical circuit.

In one embodiment, the electrical circuit is a parallel circuit of a capacitor and a resistor. The resistor is sized to prevent the second end cap from charging thereby preventing possible charge build up or uncontrolled voltage drift. The resistor is also sized to have an impedance much greater than an impedance of the capacitor at an operating frequency of the trap signal. In this manner, the excitation voltage division remains substantially constant with changing excitation voltage frequency, and the excitation voltage is substantially in phase with the signal impressed on the central electrode.

Embodiments herein are directed to generation of a trap signal and impressing a fractional part of the trap signal on the second end cap of an ion trap used for mass spectrometric chemical analysis in order to increase performance without significant added complexity, cost, or power consumption.

Embodiments operate to improve spectral resolution and eliminate double peaks in the output spectra that could otherwise be present.

Other embodiments employ switching circuits that may be employed to connect the end cap electrodes to different circuits of passive components and/or voltages at different times. In some embodiments, the electrical circuit may employ passive components that include inductors, transformers, or other passive circuit elements used to change the characteristics (such as phase) of the second end cap signal.

Embodiments are directed to improving ion trap performance by applying an additional excitation voltage across the end caps of an ion trap. Unlike the typical resonance ejection technique, this excitation voltage has a frequency equal to the center electrode excitation frequency. The generation of this excitation voltage can be accomplished using only passive components without the need for an additional signal generator or signal driver.

The details of one or more embodiments are set forth in the accompanying drawings and the description below. Other features, objects, and advantages of the invention will be apparent from the description and drawings, and from the claims.

### BRIEF DESCRIPTION OF DRAWINGS

FIG. 1 is a circuit block diagram of a prior art ion trap signal driving method showing two signal sources;

FIG. 2 is a circuit block diagram of one embodiment using a single signal source;

FIG. 3A is a cross-section view illustrating a quadrupole ion trap during one polarity of an excitation source;

FIG. 3B is a cross-section view illustrating a quadrupole ion trap during the other polarity of the excitation source; and

FIG. 4 is a circuit block diagram of another embodiment using a single signal source and switch circuits to couple passive components.

Like reference symbols in the various drawings may indicate like elements.

### DETAILED DESCRIPTION

Embodiments herein provide an electrical excitation for the end cap of an ion trap to improve ion trap operation. Embodiments provide a simple electrical circuit that derives the electrical excitation signal from the signal present on the center electrode of an ion trap.

In one embodiment, passive electrical components are used to apply a signal to the second end cap of an ion trap in order to increase performance. The added components serve to apply a percentage of the central electrode excitation signal to the second end cap. This results in an axial excitation within the ion trap that improves performance with negligible power loss, minimal complexity while having a minimum impact on system size. In some embodiments, the added components may cause an increase in the impedance seen at the central electrode due to the circuit configuration of the added components, which results in an actual reduction in overall system power consumption.

In embodiments, the frequency of the signal applied to the second end cap is the same as the frequency of the center electrode. The performance increase is afforded without performing conventional resonance ejection, since the frequency of the applied signal is equal to the frequency of the center electrode. Note that this method may be performed in tandem with conventional resonance ejection methods in order to optimize ion trap performance. This may be accomplished by additionally driving one or both end caps with a conventional resonance ejection signal source through a passive element(s) so that both the conventional resonance ejection signal and the previously described signal are simultaneously impressed upon the ion trap. One embodiment comprises applying a conventional resonance ejection signal to either end cap, and the previously described signal having the same frequency as the center electrode to the remaining end cap.

Some embodiments herein may not require retuning or adjustment when the frequency of operation is varied. Variable frequency operation without retuning is possible because the signal impressed on the second end cap is derived from the signal coupled to the central electrode through the use of a capacitive voltage divider that is substantially independent of frequency and depending only on actual capacitance values. This holds true as long as the resistance shunting the added capacitor is significantly larger than the impedance of the capacitor in the frequency range of operation.

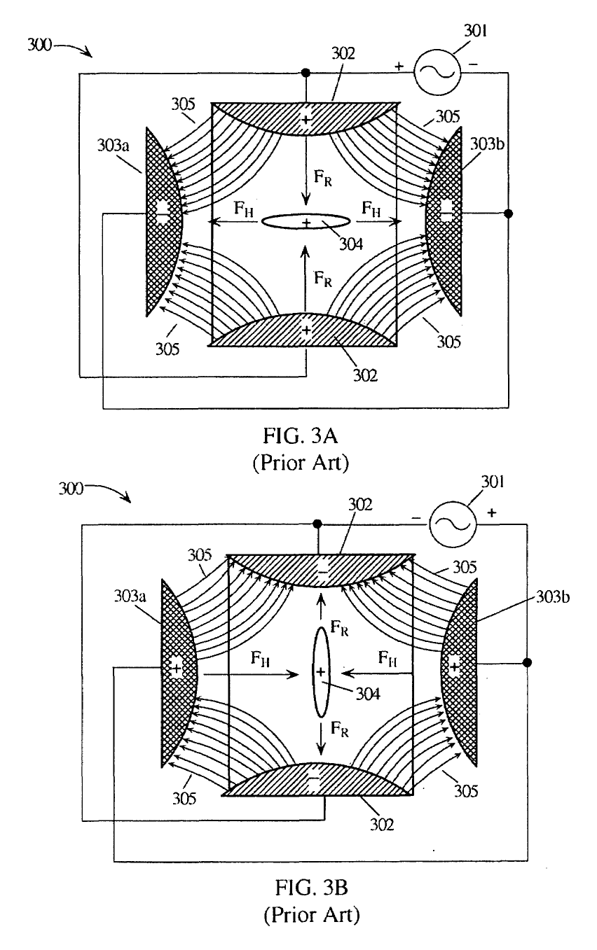

FIGS. 3A and 3B illustrate a cross-section of a prior art quadrupole ion trap 300. The ion trap 300 comprises two hyperbolic metal electrodes (end caps) 303a, 303b and a hyperbolic ring electrode 302 disposed half-way between the end cap electrodes 303a and 303b. The positively charged ions 304 are trapped between these three electrodes by electric fields 305. Ring electrode 302 is electrically coupled to one terminal of a radio frequency (RF) AC voltage source 301. The second terminal of AC voltage source 301 is coupled to hyperbolic end cap electrodes 303a and 303b. As AC voltage source 301 alternates polarity, the electric field lines 305 alternate. The ions 304 within the ion trap 300 are confined by this dynamic quadrupole field as well as fractional higher order (hexapole, octapole, etc.) electric fields.

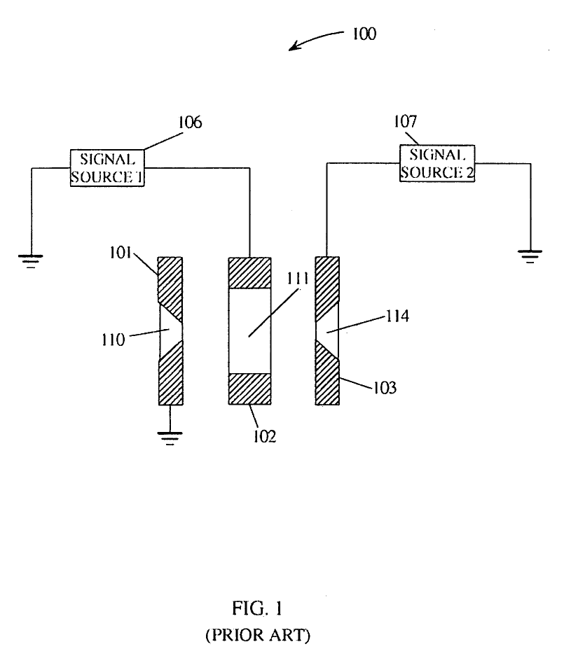

FIG. 1 is a schematic block diagram 100 illustrating cross-sections of electrodes coupled to a prior art signal driving method for an ion trap having two signal sources. The first ion trap electrode (end cap) 101 is connected to ground or zero volts. The ion trap central electrode 102 is driven by a first signal source 106. The second ion trap end cap 103 is driven by a second signal source 107. First end cap 101 has an aperture 110. Central electrode 102 is ring shaped with an aperture 111 and second end cap 103 has an aperture 114.

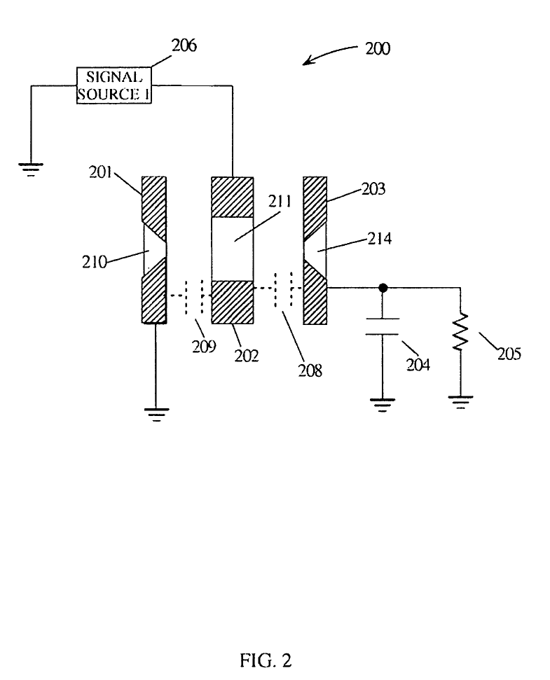

FIG. 2 is a schematic block diagram 200 illustrating cross-sections of electrodes according to one embodiment wherein an ion trap is actively driven by only one external signal source 206. First end cap 201 has an aperture 210, central electrode 202 has an aperture 211 and second end cap 203 has an aperture 214. The first ion trap end cap 201 is coupled to ground or zero volts, however, other embodiments may use other than zero volts. For example, in another embodiment the first end cap 201 may be connected to a variable DC voltage or other signal. The ion trap central electrode 202 is driven by signal source 206. The second ion trap end cap 203 is connected to zero volts by the parallel combination of a capacitor 204 and a resistor 205.

The embodiment illustrated in FIG. 2 operates in the following manner: an intrinsic capacitance 208 naturally exists between central electrode 202 and the second end cap 203. Capacitance 208 in series with the capacitance of capacitor 204 form a capacitive voltage divider thereby impressing a potential derived from signal source 206 at second end cap 203. When signal source 206 impresses a varying voltage on central electrode 202, a varying voltage of lesser amplitude is impressed upon the second end cap 203 through action of the capacitive voltage divider. Naturally, there exists a corresponding intrinsic capacitance between central electrode 202 and first end cap 201. According to one embodiment, a discrete resistor 205 is added between second end cap 203 and zero volts. Resistor 205 provides an electrical path that acts to prevent second end cap 203 from developing a floating DC potential that could cause voltage drift or excess charge build-up. In one embodiment, the value of resistor 205 is sized to be in the range of 1 to 10 Mega-ohms (MΩ) to ensure that the impedance of resistor 205 is much greater than the impedance of added capacitor 204 at an operating frequency of signal source 206. If the resistance value of resistor 205 is not much greater than the impedance of C_{A} 204, then there will be a phase shift between the signal at central electrode 202 and signal impressed on second end cap 203 by the capacitive voltage divider. If the resistance value of resistor 205 not much greater than the impedance of C_{A} 204, the amplitude of the signal impressed on second end cap 203 will vary as a function of frequency. Without resistor 205, the capacitive voltage divider (C_{S} and C_{A}) is substantially independent of frequency. In one embodiment, the value of the added capacitor 204 is made variable so that it may be adjusted to have an optimized value for a given system characteristics.

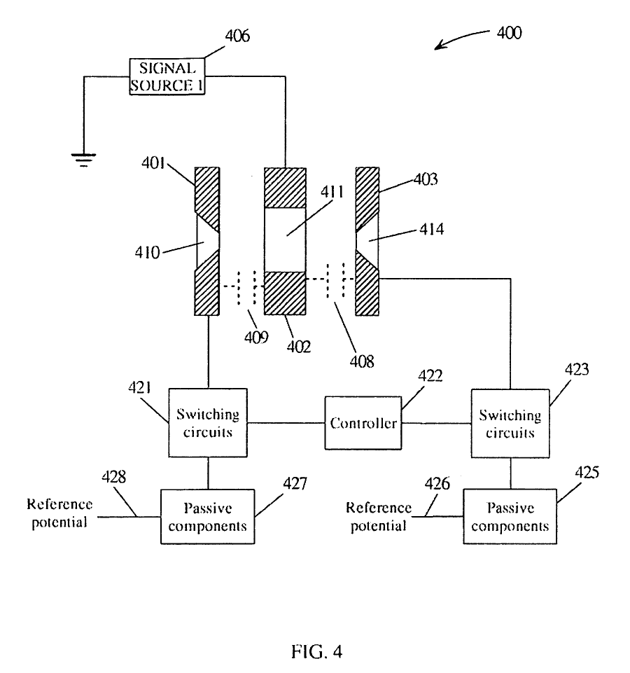

FIG. 4 is a schematic block diagram 400 illustrating cross-sections of electrodes according to one embodiment wherein an ion trap is actively driven by only one external signal source 406. Again, first end cap 401 has an aperture 410, central electrode 402 has an aperture 411 and second end cap 403 has an aperture 414. The first ion trap end cap 401 is coupled, in response to control signals from controller 422, to passive components 427 with switching circuits 421. Various components in passive components 427 may be coupled to reference voltage 428 which in some embodiments may be ground or zero volts. In another embodiment, the reference voltage 428 may be a DC or a variable voltage. The combination of switching circuits 421 and passive components 427 serve to control and modify the potential on first end cap 401 to improve the operation of the ion trap.

The second ion trap end cap 403 is coupled, in response to control signals from controller 422, to passive components 425 with switching circuits 423. Various components in passive components 425 may be coupled to reference voltage 426, which in some embodiments may be ground or zero volts. In another embodiment, the reference voltage 426 may be a DC or a variable voltage. The combination of switching circuits 423 and passive components 425 server to control and modify the potential on first end cap 402 to improve the operation of the ion trap. Capacitances 408 and 409 combine with the passive components 425 and 427 to couple a portion of signal source 406 when switched in by switching circuits 423 and 421, respectively.

A number of embodiments of the invention have been described. Nevertheless, it will be understood that various modifications may be made without departing from the spirit and scope of the invention.

1. An ion trap comprising:
a conductive ring-shaped central electrode having a first aperture extending from a first open end to a second open end;
a signal source generating a trap signal having at least an alternating current (AC) component between a first and second terminal, wherein the first terminal is coupled to the central electrode and the second terminal is coupled to a reference voltage potential;
a conductive first electrode end cap disposed adjacent to the first open end of the central electrode and coupled to the reference voltage potential, wherein a first intrinsic capacitance is formed between a surface of the first electrode end cap and a surface of the first open end of the central electrode; and
a conductive second electrode end cap disposed adjacent to the second open end of the central electrode and coupled to the reference voltage potential with a first electrical circuit, wherein a second intrinsic capacitance is formed between a surface of the second electrode end cap and a surface of the second open end of the central electrode, wherein a fractional part of the trap signal is impressed on the second electrode end cap in response to a voltage division of the trap signal by the second intrinsic capacitance and an impedance of the first electrical circuit.

2. The ion trap of claim 1, wherein the first electrical circuit comprises a capacitor in parallel with a resistor.

3. The ion trap of claim 2, wherein an impedance of the resistor is greater than one fourth of an impedance of the capacitor at a frequency of the trap signal.

4. The ion trap of claim 1, wherein the reference voltage potential is ground or zero volts.

5. The ion trap of claim 1, wherein the reference voltage potential is an adjustable DC voltage.

6. The ion trap of claim 1, wherein the capacitor is a variable capacitor adjustable to optimize an operating characteristic of the ion trap.

7. An ion trap, comprising:
a central electrode having an aperture;
a first end cap electrode having an aperture;
a second end cap electrode having an aperture;
a first electronic signal source applied to the central electrode;
a circuit of passive elements;
an electrical connection between said first end cap electrode and said circuit of passive elements; and
an electrical connection between said circuit of passive elements and a voltage potential, wherein said first end cap electrode connected to said voltage potential via said circuit of passive elements bears a voltage due to capacitive coupling between said first electronic signal source and said circuit of passive elements.

8. An ion trap claim 7, further comprising a switching circuit that electrically connects and disconnects said first end cap electrode to said circuit of passive elements.
